(19) United States
(12) Patent Application Publication
(10) Pub. No.: US 2012/0259552 A1
(43) Pub. Date: Oct. 11, 2012

(54) MONITORING THE PHASE COMPOSITION OF PRODUCTION FLUID FROM A HYDROCARBON EXTRACTION WELL

(76) Inventor: John MacLean Wingate, Bristol (GB)

(21) Appl. No.: 13/437,182

(22) Filed: Apr. 2, 2012

(30) Foreign Application Priority Data
Apr. 5, 2011 (EP) 11161211.5

(51) Int. Cl. G06F 19/00

(52) U.S. Cl. 702/13

(57) ABSTRACT

A method of monitoring a phase composition resulting from different phases in production fluid from at least one well of a plurality of hydrocarbon production wells is provided. The method comprises modulating a flow of production fluid from the at least one well; passing the flow of production fluid from each of the plurality of wells through a multiphase flow meter common to the plurality of wells; and processing data from the multiphase flow meter by responding to the modulation of the flow of the production fluid from the at least one well to produce information relating to the phase composition of the production fluid from the at least one well.

### BACKGROUND OF THE INVENTION

1. Field of the Invention

The field of the invention relates to monitoring the phase composition of production fluid from a hydrocarbon extraction well.

2. Description of Related Art

Knowledge of the phase composition of individual fluid production wells within a well complex comprising a production gathering network enables production optimization strategies to accelerate the production rate of fields. In many instances, these strategies cannot be adopted because of the high cost of having a multiphase flow meter for each well. Previous attempts to overcome this problem are by virtual multiphase flow metering, involving complex optimization algorithms that are difficult to implement and are sensitive to instrumentation errors. Embodiments of the present invention allow the benefits of production optimization to be gained, without the cost and complexity of having a flow meter for each well, and the method provides a better estimate, as its based on direct measurements.

### BRIEF SUMMARY OF THE INVENTION

According to an embodiment of the present invention a method of monitoring a phase composition resulting from different phases in production fluid from at least one well of a plurality of hydrocarbon production wells is provided. The method comprises modulating a flow of production fluid from the at least one well; passing the flow of production fluid from each of the plurality of wells through a multiphase flow meter common to the plurality of wells; and processing data from the multiphase flow meter by responding to the modulation of the flow of the production fluid from the at least one well to produce information relating to the phase composition of the production fluid from the at least one well.

According to another embodiment of the present invention a well system is provided. The well system comprises a plurality of hydrocarbon production wells; a multiphase flow meter configured to monitor a phase composition resulting from different phases in production fluid from at least one of the plurality of wells, wherein the multiphase flow meter is common to the plurality of wells; at least one choke through which the production fluid flows from at least one of the plurality of wells, the at least one choke being configured to modulate the flow of the production fluid from the at least one well; a manifold fluidly connected to each of the plurality of wells and fluidly connected to the multiphase flow meter, the manifold being configured to pass the production fluid from each of the wells through the multiphase flow meter; and a processer configured to process data from the multiphase flow meter and to respond to the modulation of the flow of production fluid from the at least one well to produce information relating to the phase composition of production fluid from the at least one well.

### BRIEF DESCRIPTION OF THE SEVERAL VIEWS OF THE DRAWINGS

FIG. 1 is a schematic block diagram of part of a well complex in which an embodiment of the invention may be carried out;

FIG. 2 shows typical waveforms resulting from different phases when performing the invention; and

FIG. 3 is a block diagram in respect of the processing of data from an MPFM of FIG. 1.

### DETAILED DESCRIPTION OF THE INVENTION

Embodiments of the present invention involve the determination of the phase composition (% oil, % gas, % water) of individual production wells feeding a common manifold, using data from a single downstream multiphase flow meter (MPFM), by modulating, at a frequency of f Hz, the production flow from one well and by digitally filtering the data from the MPFM, at the frequency f, thus extracting the phase composition of that well from the total flow. The process may be repeated for each well in turn to reveal the phase composition for all wells feeding the manifold.

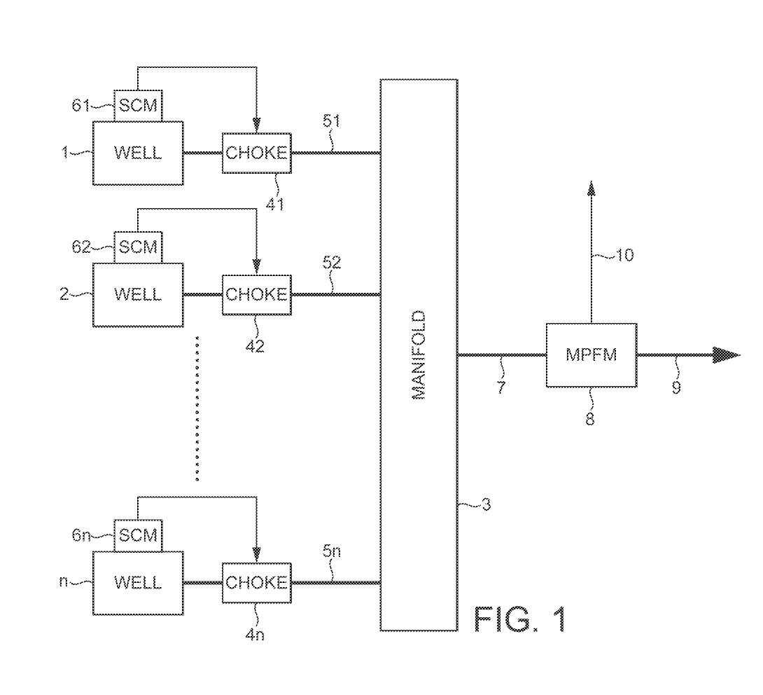

FIG. 1 shows the production flow from a well complex comprising a plurality of subsea hydrocarbon wells 1, 2 . . . n, each connected to a common manifold 3. The output of each well passes through a respective one of chokes 41, 42 . . . 4n to manifold 3 via respective ones of output lines 51, 52 . . . 5n. Each choke is controlled by a respective one of well subsea control modules (SCMs) 61, 62 . . . 6n. The combined production flow on a line 7 out of the manifold 3 passes through a single multiphase flow meter (MPFM) 8 common to the wells, before exiting the well complex on an output line 9. The data output on a communication line 10 from the multiphase flowmeter 8 is fed to a topside master control station (MCS) at the surface via the normal communication system of the subsea well complex, where it is processed to provide the phase composition of each of wells 1, 2 . . . n.

The mode of operation of the embodiments of the invention is as follows. Starting at the first well 1, its production choke 41 is modulated around its nominal set position by a sinusoidal modulating signal from the subsea electronics module (SEM) of the SCM 61 to provide a relatively small amplitude flow component at frequency f superimposed on the nominal flow for a time period t. During time t, the downstream MPFM 8 measures the phase composition of the combined flow from all of the wells feeding the manifold 3, including the flow from well 1 and its component modulated at frequency f. During time t, subsea data from the MPFM 8 is transmitted via the normal communication line 10 to the topside MCS, where it is stored. Data relating to production choke 41 of well 1 is also stored and time synchronised with the flow phase data. From the stored data, a time history of the combined production fluid phases can be obtained.

As is discussed further below, the flow of production fluid from well 1 could be modulated by frequency modulation. Also, processing of the data may comprise filtering signals from data from the multiphase flow meter.

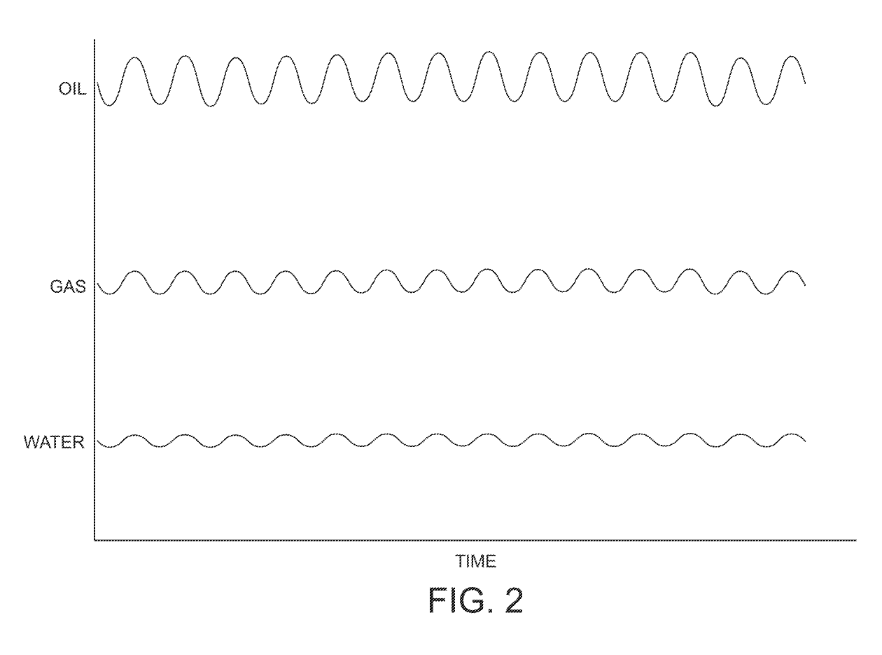

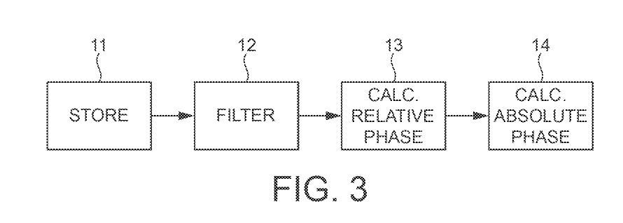

FIG. 2 is a graph that illustrates the typical resultant modulation at frequency f of each of the phases (% oil, % gas, % water) at the output line 51 of the choke 41. FIG. 3 illustrates the processing of this data stored in a store 11 at the MCS. By using an appropriately designed digital filter 12 and applying this to the time series, the components of the phases modulated at frequency f can be isolated from the combined flow. This provides flow phase data that is specific to well 1 only. The relative phase composition of well 1 (% oil, % gas, % water) can then be determined by a calculator 13 and absolute composition can then be obtained by a calculator 14 by correlating the relative composition against a measure of total flow from well 1, derived from synchronised choke data (position, pressure drop and temperature).

After this process has been completed for well 1, the modulation of well 1 flow will stop and the process repeated for well 2 through to well n such that the phase composition for each well can be determined. The process will then repeat on a cyclic basis.

In practice, the modulation of the chokes 41 . . . 4n, and thereby the production flows from them, is scheduled by the topside MCS.

As an alternative to modulation of the flows from the wells 1 . . . n in a cyclic manner, they could be modulated simultaneously if the modulation frequencies are suitably separated, with demodulation of data from the MPFM 8 occurring in the topside MCS.

The advantages of embodiments of the invention include multiphase measurements for each well with a dramatically reduced number of multi-phase flowmeters. Enablement of production optimization services. Also, no additional sensors or complex virtual flow metering algorithms are needed.

What is claimed is:

1. A method of monitoring a phase composition resulting from different phases in production fluid from at least one well of a plurality of hydrocarbon production wells, the method comprising:
modulating a flow of production fluid from the at least one well;
passing the flow of production fluid from each of the plurality of wells through a multiphase flow meter common to the plurality of wells; and
processing data from the multiphase flow meter by responding to the modulation of the flow of the production fluid from the at least one well to produce information relating to the phase composition of the production fluid from the at least one well.

2. The method of claim 1, wherein the flow of production fluid from each of the plurality of wells is modulated, the processing being carried out on data from the multiphase flow meter to produce information relating to the phase composition of production fluid for each of the plurality of wells.

3. The method of claim 2, wherein the flows of production fluid from the plurality of wells are modulated in turn, wherein information relating to the phase composition of production fluid is produced for each of the plurality of wells in turn.

4. The method of claim 2, wherein the flow of production fluid from the at least one well is modulated by modulating a respective choke through which the production fluid flows from the well.

5. The method of claim 1, wherein the flow of production fluid from the at least one well is modulated by modulating a respective choke through which the production fluid flows from the at least one well.

6. The method of claim 1, wherein the flow of production fluid from the at least one well is modulated by frequency modulation.

7. The method of claim 1, wherein the flow of production fluid from each of the plurality of wells is passed to the multiphase flow meter through a manifold common to the plurality of wells.

8. The method of claim 1, wherein the different phases comprise oil, gas and water.

9. The method of claim 1, wherein processing data from the multiphase flow meter comprises filtering signals from the data from the multiphase flow meter.

10. The method of claim 1, wherein the plurality of wells are subsea wells, and wherein processing data from the multiphase flow meter is carried out topside.

11. A well system comprising:
a plurality of hydrocarbon production wells;
a multiphase flow meter configured to monitor a phase composition resulting from different phases in production fluid from at least one of the plurality of wells, wherein the multiphase flow meter is common to the plurality of wells;
at least one choke through which the production fluid flows from at least one of the plurality of wells, the at least one choke being configured to modulate the flow of the production fluid from the at least one well;
a manifold fluidly connected to each of the plurality of wells and fluidly connected to the multiphase flow meter, the manifold being configured to pass the production fluid from each of the wells through the multiphase flow meter; and
a processer configured to process data from the multiphase flow meter and to respond to the modulation of the flow of production fluid from the at least one well to produce information relating to the phase composition of production fluid from the at least one well.

12. The system of claim 11 comprising a plurality of chokes, each of the plurality of chokes being configured to modulate the flow of production fluid from a respective well of the plurality of wells, wherein the processor is further configured to process the data from the multiphase flow meter to produce information relating to the phase composition of production fluid from each of the plurality of wells.

13. The system of claim 12, wherein the plurality of chokes are configured to modulate the flows of production fluid from the plurality of wells in turn, and wherein the processor is further configured to process data from the multiphase flow meter to produce information relating to the phase composition of production fluid from each of the plurality of wells in turn.

14. The system of claim 12, wherein the flow of production fluid from the at least one well is modulated by frequency modulation.

15. The system of claim 11, wherein the processor comprises a digital filter.

16. The system of claim 11, wherein the plurality of wells are subsea wells, and wherein the processor is located topside.
